(19) United States
(12) Patent Application Publication
(10) Pub. No.: US 2024/0379267 A1
(43) Pub. Date: Nov. 14, 2024

(54) SUPERCONDUCTING WIRE AND SUPERCONDUCTING COIL

(71) Applicant: Fujikura Ltd., Tokyo (JP)

(72) Inventors: Shinji Fujita, Sakura-shi (JP); Shogo Muto, Sakura-shi (JP)

(73) Assignee: Fujikura Ltd., Tokyo (JP)

(21) Appl. No.: 18/686,050

(22) PCT Filed: Aug. 25, 2022
(86) PCT No.: PCT/JP2022/032059

§ 371 Date: Feb. 23, 2024

(30) Foreign Application Priority Data
Aug. 26, 2021 (JP) 2021-137967

(51) Int. Cl. H01F 6/06; H01B 12/06

(52) U.S. Cl. CPC H01F 6/06; H01B 12/06

(57) ABSTRACT

A superconducting wire includes: a superconductor laminate including a metal substrate and an oxide superconducting layer; and a stabilizing portion that covers the superconductor laminate and that has a thermal expansion coefficient larger than a thermal expansion coefficient of the metal substrate. The superconductor laminate has: a first main surface on which the oxide superconducting layer is disposed, and a second main surface on which the metal substrate is disposed. The stabilizing portion includes: a first portion facing the first main surface; and a second portion facing the second main surface. A thickness of the second portion is larger than a thickness of the first portion.

### CROSS-REFERENCE TO RELATED APPLICATIONS

Priority is claimed on Japanese Patent Application No. 2021-137967, filed Aug. 26, 2021, the content of which is incorporated herein by reference.

### TECHNICAL FIELD

The present invention relates to a superconducting wire and a superconducting coil.

### BACKGROUND

A superconducting wire described in Patent Document 1 includes a laminate in which a substrate, an intermediate layer, an oxide superconducting layer, and a protection layer are laminated, a stabilizing layer covering the laminate, and a metal tape formed on one surface of the stabilizing layer. The metal tape is formed on a surface of two surfaces of the stabilizing layer on a side where the oxide superconducting layer of the laminate is formed. The substrate is made of, for example, Hastelloy (registered trademark). The stabilizing layer and the metal tape are made of, for example, copper.

### PATENT LITERATURE

### Patent Document 1

Japanese Unexamined Patent Application, First Publication No. 2011-40176

Due to the contraction of the superconducting wire caused by a change in temperature, there is a possibility that the oxide superconducting layer is damaged and the superconducting characteristics deteriorate. For example, when the superconducting wire is cooled to a critical temperature or less (approximately 90 K or less in the case of a Y-based superconducting wire), the superconducting wire contracts and deforms, and a shear stress caused by the difference in the thermal expansion coefficient between the substrate (Hastelloy (registered trademark)) and both the stabilizing layer and the metal tape (both made of copper) is applied to the oxide superconducting layer. Accordingly, there is a possibility that the oxide superconducting layer is damaged and the characteristics of the superconducting wire deteriorate.

### SUMMARY

One or more embodiments of the present invention provide a superconducting wire and a superconducting coil in which a deterioration in superconducting characteristics due to a change in temperature is less likely to occur.

According to one or more embodiments of the present invention, there is provided a superconducting wire including a superconductor laminate including a metal substrate and an oxide superconducting layer, and a stabilizing portion formed to cover the superconductor laminate and having a thermal expansion coefficient larger than a thermal expansion coefficient of the metal substrate, in which the superconductor laminate has a first main surface that is a surface on a side where the oxide superconducting layer is provided, and a second main surface that is a surface on a side where the metal substrate is provided, the stabilizing portion includes a first portion facing the first main surface, and a second portion facing the second main surface, and a thickness of the second portion is larger than a thickness of the first portion.

According to one or more embodiments of the present invention, since the second portion of the stabilizing portion is thicker than the first portion, even when the stabilizing portion contracts due to a change in temperature, a shear stress is less likely to act on the oxide superconducting layer. For that reason, damage to the oxide superconducting layer can be suppressed. Therefore, a deterioration in the superconducting characteristics of the superconducting wire can be suppressed.

A difference between the thickness of the first portion and the thickness of the second portion may be larger than a thickness of the metal substrate.

The stabilizing portion may include a first stabilizing layer surrounding the superconductor laminate, and a second stabilizing layer made of a metal tape and joined to a portion of the first stabilizing layer, which faces the second main surface.

A non-orientation region extending in a longitudinal direction of the oxide superconducting layer may be formed in the oxide superconducting layer.

According to one or more embodiments of the present invention, there is provided a superconducting coil including the superconducting wire, in which the superconducting wire is wound such that the first portion is located inside the second portion in a radial direction.

According to one or more embodiments of the present invention, it is possible to provide a superconducting wire and a superconducting coil in which a deterioration in superconducting characteristics due to a change in temperature is less likely to occur.

### BRIEF DESCRIPTION OF THE DRAWINGS

FIG. 1 is a cross-sectional view of an oxide superconducting wire of a first embodiment.

FIG. 2 is a schematic view of a superconducting coil of the first embodiment.

FIG. 3 is a cross-sectional view of an oxide superconducting wire of a second embodiment.

FIG. 4 is a cross-sectional view of an oxide superconducting wire of a modification example of the first embodiment.

### DETAILED DESCRIPTION

Hereinafter, the present invention will be described with reference to the drawings, based on one or more embodiments.

### [Oxide Superconducting Wire]

### First Embodiment

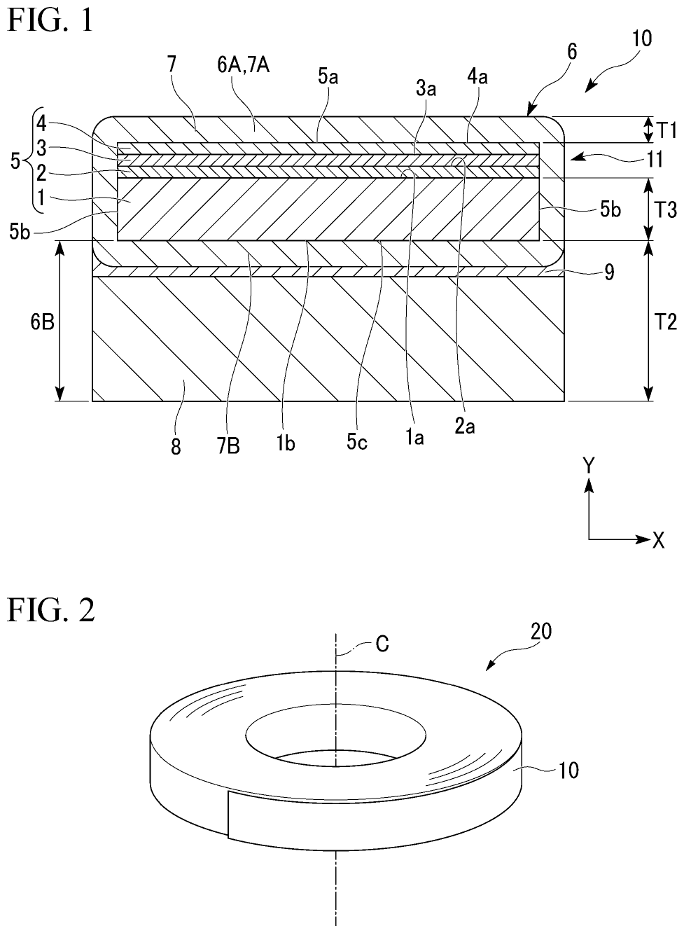

FIG. 1 is a cross-sectional view of an oxide superconducting wire 10 of a first embodiment. FIG. 1 is a view of a cross section orthogonal to a longitudinal direction of the oxide superconducting wire 10.

As shown in FIG. 1, the oxide superconducting wire 10 includes a superconductor laminate 5 and a stabilizing portion 6. The oxide superconducting wire 10 is a specific example of a “superconducting wire”.

The superconductor laminate 5 includes a metal substrate 1, an intermediate layer 2, an oxide superconducting layer 3, and a protection layer 4. The superconductor laminate 5 has a structure in which the oxide superconducting layer 3 and the protection layer 4 are formed on the metal substrate 1 with the intermediate layer 2 sandwiched therebetween. Namely, the superconductor laminate 5 has a configuration in which the intermediate layer 2, the oxide superconducting layer 3, and the protection layer 4 are laminated in order on one surface of the metal substrate 1 having a tape shape.

The oxide superconducting wire 10 is formed in a tape shape. In the following description, the thickness direction of the oxide superconducting wire 10 is referred to as a thickness direction Y. The thickness direction Y is a direction in which the metal substrate 1, the intermediate layer 2, the oxide superconducting layer 3, and the protection layer 4 are laminated. A direction from the metal substrate 1 toward the oxide superconducting layer 3 along the thickness direction Y is referred to as an up direction, and the opposite direction is referred to as a down direction. The width direction of the oxide superconducting wire 10 is referred to as a width direction X. The width direction X is a direction orthogonal to the longitudinal direction and the thickness direction of the oxide superconducting wire 10.

The metal substrate 1 is made of metal. Specific exemplary examples of the metal constituting the metal substrate 1 are a nickel alloy such as Hastelloy (registered trademark), stainless steel, and an oriented Ni—W alloy with a texture introduced into a nickel alloy, and the like. The thickness of the metal substrate 1 may be adjusted as appropriate for the purpose, and is, for example, in a range of 10 to 500 μm. The one surface (a surface on which the intermediate layer 2 is formed) of the metal substrate 1 is referred to as a first surface 1a, and a surface opposite to the first surface 1a is referred to as a second surface 1b.

The intermediate layer 2 is provided between the metal substrate 1 and the oxide superconducting layer 3. The intermediate layer 2 is formed on the first surface 1a of the metal substrate 1. The intermediate layer 2 may have a multilayer configuration, and may include, for example, a diffusion prevention layer, a bed layer, a textured layer, a cap layer, and the like in order from a side of the metal substrate 1 to a side of the oxide superconducting layer 3. These layers are not always provided one by one, and some layers may be omitted, or two or more layers of the same type may be repeatedly laminated. The intermediate layer 2 is not an essential configuration in the oxide superconducting wire 10, and the intermediate layer 2 may not be formed when the metal substrate 1 itself has an orientation.

The diffusion prevention layer has a function of suppressing some components of the metal substrate 1 from diffusing and being mixed as impurities into the oxide superconducting layer 3. The diffusion prevention layer is made of, for example, Si₃N₄, Al₂O₃, GZO (Gd₂Zr₂O₇), or the like. The thickness of the diffusion prevention layer is, for example, 10 nm to 400 nm.

The bed layer may be formed on the diffusion prevention layer. The bed layer is provided to reduce a reaction at an interface between the metal substrate 1 and the oxide superconducting layer 3 and improve the orientation of a layer formed on the bed layer. Exemplary examples of the material of the bed layer are Y₂O₃, Er₂O₃, CeO₂, Dy₂O₃, Eu₂O₃, Ho₂O₃, La₂O₃, and the like. The thickness of the bed layer is, for example, 10 nm to 100 nm.

The textured layer is formed of a biaxially textured material to control the crystal epitaxy of the cap layer formed on the textured layer. Exemplary examples of the material of the textured layer are metal oxides such as Gd₂Zr₂O₇, MgO, ZrO₂—Y₂O₃ (YSZ), SrTiO₃, CeO₂, Y₂O₃, Al₂O₃, Gd₂O₃, Zr₂O₃, Ho₂O₃, and Nd₂O₃. The textured layer may be formed by an Ion-Beam-Assisted Deposition (IBAD) method.

The cap layer is formed on a surface of the textured layer, and is formed of a material that allows crystal grains to be self-epitaxy in the in-plane direction. Exemplary examples of the material of the cap layer are CeO₂, Y₂O₃, Al₂O₃, Gd₂O₃, ZrO₂, YSZ, Ho₂O₃, Nd₂O₃, LaMnO₃, and the like. The thickness of the cap layer is in a range of 50 to 5000 nm.

The oxide superconducting layer 3 is configured with an oxide superconductor. The oxide superconductor is not particularly limited, and exemplary examples of the oxide superconductor are a RE-Ba—Cu—O-based oxide superconductor (REBCO-based superconductor) represented by a general formula REBa₂Cu₃Oₓ (RE123), and the like. Exemplary examples of the rare earth element RE are one or two or more of Y, La, Ce, Pr, Nd, Sm, Eu, Gd, Tb, Dy, Ho, Er, Tm, Yb, and Lu. Among these elements, one of Y, Gd, Eu, and Sm or a combination of two or more of these elements may be used. In the general formula of RE123, X is 7-x (oxygen deficiency amount x: approximately 0 to 1). The thickness of the oxide superconducting layer 3 is, for example, in a range of 0.5 to 5 μm. The thickness of the oxide superconducting layer 3 may be uniform in the longitudinal direction. The oxide superconducting layer 3 is formed on a main surface 2a (a surface opposite to the side of the metal substrate 1) of the intermediate layer 2.

The protection layer 4 has a function of bypassing an overcurrent generated in the event of an accident or suppressing a chemical reaction occurring between the oxide superconducting layer 3 and a layer provided on the protection layer 4. Exemplary examples of the material of the protection layer 4 are silver (Ag), copper (Cu), gold (Au), an alloy of gold and silver, other silver alloys, copper alloys, gold alloys, and the like. The protection layer 4 covers at least a main surface 3a (a surface opposite to a side of the intermediate layer 2) of the oxide superconducting layer 3. The thickness of the protection layer 4 is not particularly limited, and is, for example, in a range of 1 to 30 μm.

The superconductor laminate 5 has a first main surface 5a, side surfaces 5b and 5b, and a second main surface 5c. The first main surface 5a is a main surface 4a of the protection layer 4. The first main surface 5a is a surface of the superconductor laminate 5 on a side where the oxide superconducting layer 3 is provided. The side surfaces 5b are side surfaces of the metal substrate 1, side surfaces of the intermediate layer 2, side surfaces of the oxide superconducting layer 3, and side surfaces of the protection layer 4. The second main surface 5c is a surface opposite to the first main surface 5a. The second main surface 5c is the second surface 1b of the metal substrate 1. The second main surface 5c is a surface of the superconductor laminate 5 on a side where the metal substrate 1 is provided.

The stabilizing portion 6 includes a first stabilizing layer 7 and a second stabilizing layer 8. The stabilizing portion 6 has a function as a bypass portion that commutates an overcurrent generated when the oxide superconducting layer 3 transitions to a normal conducting state.

The thermal expansion coefficient of the stabilizing portion 6 is larger than the thermal expansion coefficient of the metal substrate 1. For example, the thermal expansion coefficient of Hastelloy (registered trademark) as the constituent material of the metal substrate 1 is 10.9×10⁻⁶/° C., and the thermal expansion coefficient of copper as the constituent material of the stabilizing portion 6 is 16.7×10⁻⁶/° C.

The first stabilizing layer 7 covers the first main surface 5a, the side surfaces 5b and 5b, and the second main surface 5c of the superconductor laminate 5. The first stabilizing layer 7 is integrally formed to surround the superconductor laminate 5. The first stabilizing layer 7 is formed from the first main surface 5a to the second main surface 5c.

Exemplary examples of the constituent material of the first stabilizing layer 7 are metals such as copper, copper alloys (for example, a Cu—Zn alloy, a Cu—Ni alloy, and the like), aluminum, aluminum alloys, and silver. The thickness of the first stabilizing layer 7 is, for example, in a range of 10 to 500 μm. The first stabilizing layer 7 can be formed, for example, by plating (for example, electroplating).

The first stabilizing layer 7 includes an upper portion 7A and a lower portion 7B. The upper portion 7A is a portion of the first stabilizing layer 7, which faces the first main surface 5a. The upper portion 7A is a first portion 6A of the stabilizing portion 6 (a portion of the stabilizing portion 6, which faces the first main surface 5a). The thickness of the upper portion 7A (first portion 6A) is referred to as T1. The lower portion 7B is a portion of the first stabilizing layer 7, which faces the second main surface 5c.

The superconductor laminate 5 and the first stabilizing layer 7 constitute a superconducting wire body 11.

The second stabilizing layer 8 is made of a metal tape. Exemplary examples of the metal constituting the metal tape are metals such as copper, copper alloys (for example, a Cu—Zn alloy, a Cu—Ni alloy, and the like), aluminum, aluminum alloys, and silver. The second stabilizing layer 8 may be a copper tape.

Examples of the thermal expansion coefficients of the metals provided as the exemplary examples of the constituent materials of the first stabilizing layer 7 and the second stabilizing layer 8 are shown below. The thermal expansion coefficient of the Cu—Zn alloy is 19.1×10⁻⁶/° C., the thermal expansion coefficient of the Cu—Ni alloy is 13.8×10⁻⁶/° C., the thermal expansion coefficient of aluminum is 23.1×10⁻⁶/° C., the thermal expansion coefficient of Al-6061 that is one example of the aluminum alloy is 22.5×10⁻⁶/° C., and the thermal expansion coefficient of silver is 18.5×10⁻⁶/° C. These thermal expansion coefficients are values at room temperature (293 K).

The second stabilizing layer 8 is joined to a lower surface of the first stabilizing layer 7 (an outer surface of the lower portion 7B) by a joining material 9. Exemplary examples of the material constituting the joining material 9 are metals such as solder, Sn, Sn alloys, indium (In), and In alloys. Exemplary examples of the solder are Sn—Pb-based, Pb—Sn—Sb-based, Sn—Pb—Bi-based, Bi—Sn-based, Sn—Cu-based, Sn—Pb—Cu-based, and Sn—Ag-based alloys.

A portion of the stabilizing portion 6, which faces the second main surface 5c, is referred to as a second portion 6B. The second portion 6B includes the lower portion 7B of the first stabilizing layer 7, the joining material 9, and the second stabilizing layer 8. The thickness of the second portion 6B is referred to as T2. The thickness T2 is the sum of the thickness of the lower portion 7B, the thickness of the joining material 9, and the thickness of the second stabilizing layer 8.

The thickness T2 of the second portion 6B is larger than the thickness T1 of the first portion 6A (upper portion 7A). Since the thickness T2 is larger than the thickness T1, a shear stress generated by the contraction of the stabilizing portion 6 due to a change in temperature is less likely to act on the oxide superconducting layer 3. For example, the stabilizing portion 6 contracts and deforms during cooling; however, since the first portion 6A is thinner than the second portion 6B, the shear stress is less likely to act on the oxide superconducting layer 3.

The difference (T2−T1) between the thickness T2 of the second portion 6B and the thickness T1 of the upper portion 7A (first portion 6A) may be larger than the thickness T3 of the metal substrate 1. Since the difference (T2−T1) is larger than the thickness T3, the shear stress generated by the contraction of the stabilizing portion 6 due to a change in temperature is less likely to act on the oxide superconducting layer 3.

FIG. 2 is a schematic view of a superconducting coil 20. As shown in FIG. 2, the superconducting coil 20 is made of the oxide superconducting wire 10. The superconducting coil 20 is a multilayer winding coil in which the oxide superconducting wire 10 is laminated in the thickness direction and is wound a plurality of times. The oxide superconducting wire 10 is wound around a winding axis C. The superconducting coil 20 is formed in an annular shape, and is also referred to as a pancake coil. When viewed from the winding axis C, a direction around the winding axis C is referred to as a circumferential direction of the superconducting coil 20. A direction orthogonal to the winding axis C is referred to as a radial direction of the superconducting coil 20. A direction toward the winding axis C along the radial direction is referred to as a radially inner side, and a direction away from the winding axis C along the radial direction is referred to as a radially outer side.

The oxide superconducting wire 10 may be wound around the winding axis C such that the metal substrate 1 faces the radially outer side and the oxide superconducting layer 3 faces the radially inner side. Namely, the oxide superconducting wire 10 may be wound around the winding axis C such that the oxide superconducting layer 3 is located inside the metal substrate 1 in the radial direction. By winding the oxide superconducting wire 10 such that the oxide superconducting layer 3 is located inside the metal substrate 1 in the radial direction, the oxide superconducting layer 3 is pressed against the metal substrate 1 by a Lorentz force acting in the radial direction of the superconducting coil 20. For that reason, a deterioration in superconducting characteristics due to the oxide superconducting layer 3 being peeled off from the metal substrate 1 can be suppressed.

The superconducting coil 20 may have a configuration in which an insulating tape is wound around the oxide superconducting wire 10. The superconducting coil 20 may be impregnated with resin such as epoxy resin.

### [Effects Achieved by Oxide Superconducting Wire of First Embodiment]

In the oxide superconducting wire 10, the thickness T2 of the second portion 6B of the stabilizing portion 6 is larger than the thickness T1 of the first portion 6A (upper portion 7A). When the oxide superconducting wire 10 is exposed to a change in temperature, the stabilizing portion 6 contracts. Since the thickness T2 is larger than the thickness T1, namely, the thickness T1 is smaller than the thickness T2, a shear force generated by the contraction of the first portion 6A is smaller than a shear force generated by the contraction of the second portion 6B. Since the oxide superconducting layer 3 is formed on a side closer to the first portion 6A than to the second portion 6B, the shear stress generated by the contraction of the stabilizing portion 6 is less likely to act on the oxide superconducting layer 3. For that reason, damage to the oxide superconducting layer 3 can be suppressed. Therefore, a deterioration in the superconducting characteristics of the oxide superconducting wire 10 can be suppressed.

As a comparison, an oxide superconducting wire in which the second stabilizing layer 8 is not joined to the outer surface of the lower portion 7B of the first stabilizing layer 7 (lower surface of the first stabilizing layer 7) but joined to the outer surface of the upper portion 7A (upper surface of the first stabilizing layer 7) is assumed. In this oxide superconducting wire, the first portion of the stabilizing portion is thicker than the second portion. In this oxide superconducting wire, a shear stress is likely to act on the oxide superconducting layer 3 due to the contraction of the second stabilizing layer 8 caused by a change in temperature. The thicker the second stabilizing layer 8 is, the more the shear stress tends to increase.

### [Oxide Superconducting Wire]

### SECOND EMBODIMENT

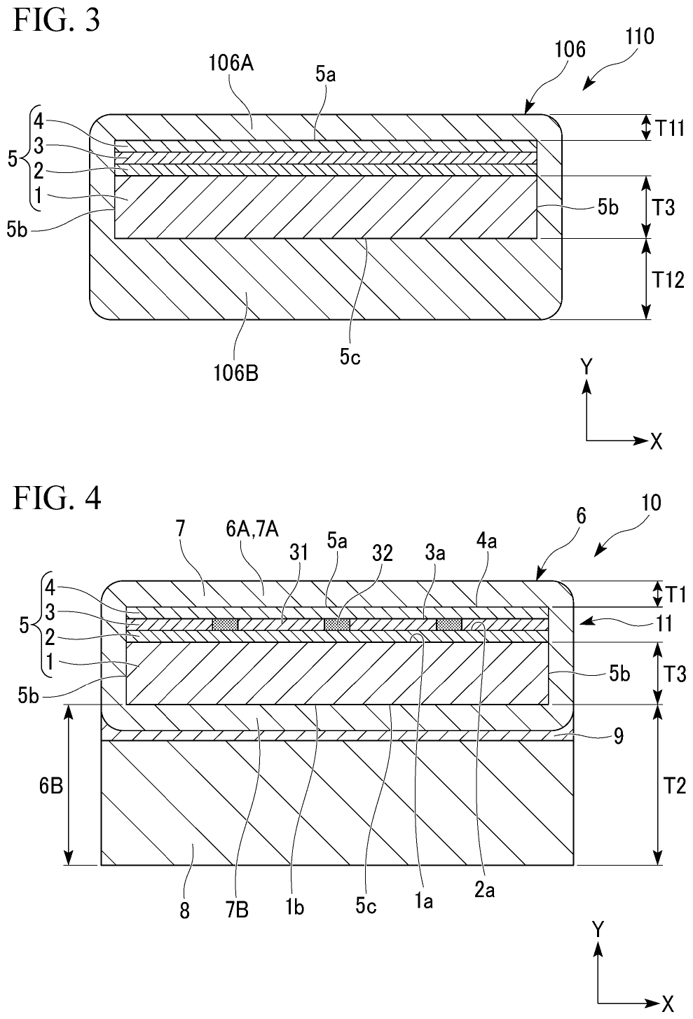

FIG. 3 is a cross-sectional view of an oxide superconducting wire 110 of a second embodiment. Configurations common to the first embodiment will be denoted by the same reference signs, and the descriptions thereof will be omitted.

As shown in FIG. 3, the oxide superconducting wire 110 includes the superconductor laminate 5 and a stabilizing portion 106. The oxide superconducting wire 110 is a specific example of the “superconducting wire”.

The stabilizing portion 106 is a layer that is integrally formed to cover the superconductor laminate 5. The stabilizing portion 106 covers the first main surface 5a, the side surfaces 5b and 5b, and the second main surface 5c of the superconductor laminate 5. The stabilizing portion 106 is formed to surround the superconductor laminate 5. The stabilizing portion 106 is formed from the first main surface 5a to the second main surface 5c.

The thermal expansion coefficient of the stabilizing portion 106 is larger than the thermal expansion coefficient of the metal substrate 1. Exemplary examples of the constituent material of the stabilizing portion 106 are metals such as copper, copper alloys (for example, a Cu—Zn alloy, a Cu—Ni alloy, and the like), aluminum, aluminum alloys, and silver. The stabilizing portion 106 can be formed, for example, by plating (for example, electroplating).

A portion of the stabilizing portion 106, which faces the first main surface 5a, is referred to as a first portion 106A. The thickness of the first portion 106A is referred to as T11. A portion of the stabilizing portion 106, which faces the second main surface 5c, is referred to as a second portion 106B. The thickness of the second portion 106B is referred to as T12.

The thickness T12 of the second portion 106B is larger than the thickness T11 of the first portion 106A. Since the thickness T12 is larger than the thickness T11, a shear stress generated by the contraction of the stabilizing portion 106 due to a change in temperature is less likely to act on the oxide superconducting layer 3. For example, the stabilizing portion 106 contracts and deforms during cooling; however, since the first portion 106A is thinner than the second portion 106B, the shear stress is less likely to act on the oxide superconducting layer 3.

The difference (T12−T11) between the thickness T12 of the second portion 106B and the thickness T11 of the first portion 106A may be larger than the thickness T3 of the metal substrate 1. Since the difference (T12−T11) is larger than the thickness T3, the shear stress generated by the contraction of the stabilizing portion 106 due to a change in temperature is less likely to act on the oxide superconducting layer 3.

### [Effects Achieved by Oxide Superconducting Wire of Second Embodiment]

In the oxide superconducting wire 110, the thickness T12 of the second portion 106B of the stabilizing portion 106 is larger than the thickness T11 of the first portion 106A. When the oxide superconducting wire 110 is exposed to a change in temperature, the stabilizing portion 106 contracts. Since the thickness T12 is larger than the thickness T11, namely, the thickness T11 is smaller than the thickness T12, a shear force generated by the contraction of the first portion 106A is smaller than a shear force generated by the contraction of the second portion 106B. Since the oxide superconducting layer 3 is formed on a side closer to the first portion 106A than to the second portion 106B, the shear stress generated by the contraction of the stabilizing portion 106 is less likely to act on the oxide superconducting layer 3. For that reason, damage to the oxide superconducting layer 3 can be suppressed. Therefore, a deterioration in the superconducting characteristics of the oxide superconducting wire 110 can be suppressed.

The present invention has been described above based on one or more embodiments; however, the present invention is not limited to the embodiments described above, and various modifications can be made without departing from the concept of the present invention. For example, in the oxide superconducting wire 10 shown in FIG. 1, the second stabilizing layer 8 is joined to the first stabilizing layer 7 by the joining material 9; however, the second stabilizing layer 8 may be directly joined to the first stabilizing layer 7 without using the joining material 9. In this case, the second stabilizing layer 8 is joined to the first stabilizing layer 7, for example, by ultrasound joining, diffusion joining, or the like.

The structure of the superconductor laminate is not limited to the structure shown in FIG. 1. The superconductor laminate may not include the protection layer. The superconductor laminate may include layers other than the metal substrate, the intermediate layer, the oxide superconducting layer, and the protection layer.

FIG. 4 is a cross-sectional view of the oxide superconducting wire 10 of a modification example of the first embodiment. As shown in FIG. 4, in the present modification example, a non-orientation region (non-superconducting region) 32 is formed in the oxide superconducting layer 3. Namely, the oxide superconducting layer 3 has an orientation region (superconducting region) 31 and the non-orientation region 32. For example, the non-orientation region 32 may be formed by forming a groove in the metal substrate 1 or the intermediate layer 2 and providing the oxide superconducting layer 3 on the groove. The non-orientation region 32 extends in the longitudinal direction of the oxide superconducting layer 3. A plurality of the non-orientation regions 32 are disposed side by side in the width direction X. The non-orientation regions 32 has a disarrayed orientation and thus do not have superconducting characteristics. Therefore, during use, the currents do not easily flow through the non-orientation regions 32, and the oxide superconducting layer 3 is substantially fragmented in the width direction. When the oxide superconducting layer 3 is fragmented in the width direction by the non-orientation regions 32, the oxide superconducting layer 3 is thinned (multifilamented). Therefore, the shielding current and magnetization loss of the oxide superconducting wire 10 can be reduced, and a deterioration in the characteristics of the superconducting coil 20 can be suppressed.

Here, in the oxide superconducting wire 10 in which the oxide superconducting layer 3 is thinned, there is a possibility that a coupling current flows between the orientation regions 31 adjacent to each other with the non-orientation region 32 sandwiched therebetween, via the stabilizing portion 6 (first portion 6A). There is a possibility that the coupling current may deteriorate the characteristics of the superconducting coil 20. However, since the first portion 6A of the stabilizing portion 6 is thinner than the second portion 6B, it is difficult for the coupling current to flow between the orientation regions 31 compared to a case where the first portion 6A is thicker than the second portion 6B. Therefore, a deterioration in the characteristics of the superconducting coil 20 caused by the coupling current can be suppressed.

In addition, similarly to the above-described modification example, in the oxide superconducting wire 110 of the second embodiment, the non-orientation regions 32 may be formed in the oxide superconducting layer 3. Namely, in the oxide superconducting wire 110, the oxide superconducting layer 3 may have the orientation regions 31 and the non-orientation regions 32. Even in this case, since the oxide superconducting layer 3 is thinned (multifilamented) by the non-orientation regions 32, the shielding current and magnetization loss of the oxide superconducting wire 10 can be reduced, and a deterioration in the characteristics of the superconducting coil 20 can be suppressed. In addition, since the first portion 106A of the stabilizing portion 106 is thinner than the second portion 106B, it is difficult for the coupling current to flow between the orientation regions 31 compared to a case where the first portion 106A is thicker than the second portion 106B. Therefore, a deterioration in the characteristics of the superconducting coil 20 caused by the coupling current can be suppressed.

### EXAMPLES

Hereinafter, the present invention will be specifically described with reference to Examples.

### Examples 1 to 3

Samples of the oxide superconducting wire 10 shown in FIG. 1 were produced as follows.

The intermediate layer 2 was formed on one surface of the metal substrate 1 having a tape shape and made of Hastelloy (registered trademark). The intermediate layer 2 had a configuration in which the diffusion prevention layer, the bed layer, the textured layer, and the cap layer were laminated in order. The oxide superconducting layer 3 made of GdBCO was formed on the intermediate layer 2. The protection layer 4 made of Ag was formed on the oxide superconducting layer 3. Accordingly, the superconductor laminate 5 was obtained. The first stabilizing layer 7 made of copper was formed on the outer surfaces of the superconductor laminate 5 by electroplating, and the superconducting wire body 11 having a width of 4 mm was obtained. The second stabilizing layer 8 that is a copper tape was joined to the lower surface of the first stabilizing layer 7 (outer surface of the lower portion 7B) using a solder as the joining material 9. Accordingly, the stabilizing portion 6 was formed.

The samples of the oxide superconducting wire 10 were placed in liquid nitrogen, and a critical current (Ic) was measured.

Samples of the superconducting wire (namely, the superconductor laminate 5) before the stabilizing portion 6 was formed were produced, the samples were placed in liquid nitrogen, and a critical current (Ic0) was measured.

When a ratio (Ic/Ic0) of the critical current (Ic) of the oxide superconducting wire 10 to the critical current (Ic0) of the superconductor laminate 5 was 0.95 or more, it was determined that superconducting characteristics did not deteriorate. When Ic/Ic0 was less than 0.95, it was determined that the superconducting characteristics deteriorated. A case where the superconducting characteristics do not deteriorate is considered a “pass”. A case where the superconducting characteristics deteriorate is considered as a “fail”. The results are shown in Table 1.

### Example 4

A sample of the oxide superconducting wire 110 shown in FIG. 3 was produced as follows.

The stabilizing portion 106 made of copper was formed on the outer surfaces of the superconductor laminate 5 produced in the same manner as in Examples 1 to 3, by electroplating, and the oxide superconducting wire 110 was obtained.

For the sample of the oxide superconducting wire 110, the presence or absence of a deterioration in superconducting characteristics was determined in the same manner as in Examples 1 to 3. The results are shown in Table 1.

### Comparative Examples 1 and 2

Samples of an oxide superconducting wire were produced according to Example 1 except that the second stabilizing layer 8 was joined to the outer surface of the upper portion 7A of the first stabilizing layer 7 (upper surface of the first stabilizing layer 7). For the samples, the presence or absence of a deterioration in superconducting characteristics was determined in the same manner as in Examples 1 to 3. The results are shown in Table 1.

### Comparative Example 3

A sample of an oxide superconducting wire was produced according to Example 4 except that the first portion of the stabilizing portion was thicker than the second portion. For the samples, the presence or absence of a deterioration in superconducting characteristics was determined in the same manner as in Examples 1 to 3. The results are shown in Table 1.

### Reference Example 1

A sample of an oxide superconducting wire was produced in the same manner as in Comparative Example 1 except that the second stabilizing layer 8 was relatively thin. For the sample, the presence or absence of a deterioration in superconducting characteristics was determined in the same manner as in Examples 1 to 3. The results are shown in Table 1.

TABLE 1

| | | | | | | | | Difference between | |
|---|---|---|---|---|---|---|---|---|---|
| | | Thickness of first portion | | | Thickness of second portion | | | thickness T1 of | |
| | | of stabilizing material | | | of stabilizing material | | | first portion and | Presence or |
| | Thickness | [μm] | | | [μm] | | | thickness T2 of | absence of |
| | of metal | | First | Second | | First | Second | second portion | deterioration in |
| | substrate | | stabilizing | stabilizing | | stabilizing | stabilizing | (T2 − T1) | superconducting |
| | [μm] | Total | layer | layer | Total | layer | layer | [μm] | characteristics |
| Example 1 | 50 | 20 | 20 | 0 | 40 | 20 | 20 | 20 | Pass |
| Example 2 | 50 | 20 | 20 | 0 | 70 | 20 | 50 | 50 | Pass |
| Example 3 | 50 | 20 | 20 | 0 | 320 | 20 | 300 | 300 | Pass |
| Example 4 | 50 | 20 | 20 | 0 | 70 | 70 | 0 | 50 | Pass |
| Comparative | 50 | 70 | 20 | 50 | 20 | 20 | 0 | −50 | Fail |
| Example 1 | | | | | | | | | |
| Comparative | 50 | 320 | 20 | 300 | 20 | 20 | 0 | −300 | Fail |
| Example 2 | | | | | | | | | |
| Comparative | 50 | 70 | 70 | 0 | 20 | 20 | 0 | −50 | Fail |
| Example 3 | | | | | | | | | |
| Reference | 50 | 40 | 20 | 20 | 20 | 20 | 0 | −20 | Pass |
| Example 1 | | | | | | | | | |

As shown in Table 1, in Examples 1 to 4, a deterioration in superconducting characteristics could be suppressed. On the other hand, in Comparative Examples 1 to 3, a deterioration in superconducting characteristics was observed.

In Reference Example 1, no deterioration in superconducting characteristics was observed. The reason is considered that the first portion is thin.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1: Metal substrate
3: Oxide superconducting layer
4: Protection layer
5: Superconductor laminate
5a: First main surface
5c: Second main surface
6, 106: Stabilizing portion
6A, 106A: First portion
6B, 106B: Second portion
7: First stabilizing layer
7B: Lower portion (portion facing second main surface)
8: Second stabilizing layer
10, 110: Oxide superconducting wire (superconducting wire)
20: Superconducting coil
32: Non-orientation region
T1, T11: Thickness of first portion
T2. T12: Thickness of second portion

1. A superconducting wire comprising:
a superconductor laminate comprising a metal substrate and an oxide superconducting layer; and
a stabilizing portion that covers the superconductor laminate and that has a thermal expansion coefficient larger than a thermal expansion coefficient of the metal substrate, wherein
the superconductor laminate has:
a first main surface on which the oxide superconducting layer is disposed, and
a second main surface on which the metal substrate is disposed,
the stabilizing portion comprises:
a first portion facing the first main surface; and
a second portion facing the second main surface, and
a thickness of the second portion is larger than a thickness of the first portion.

2. The superconducting wire according to claim 1, wherein a difference between the thickness of the first portion and the thickness of the second portion is larger than a thickness of the metal substrate.

3. The superconducting wire according to claim 1, wherein the stabilizing portion comprises:
a first stabilizing layer surrounding the superconductor laminate; and
a second stabilizing layer:
made of a metal tape, and
joined to a portion of the first stabilizing layer, that faces the second main surface of the superconductor laminate.

4. The superconducting wire according to claim 1, wherein the oxide superconducting layer comprises a non-orientation region extending in a longitudinal direction of the oxide superconducting layer.

5. A superconducting coil comprising:
the superconducting wire according to claim 1, wherein
the superconducting wire is wound such that the first portion of the stabilizing portion is disposed radially inward the second portion of the stabilizing portion in the superconducting coil.
